(19) United States
(12) Patent Application Publication
(10) Pub. No.: US 2020/0029486 A1
(43) Pub. Date: Jan. 30, 2020

(54) Closing Wheel Downforce Adjustment Devices, Systems, And Methods

(71) Applicant: Ag Leader Technology, Ames, IA (US)

(72) Inventors: Brett Buehler, Dallas Center, IA (US); Steve Bruening, Nevada, IA (US)

(21) Appl. No.: 16/523,343

(22) Filed: Jul. 26, 2019

Related U.S. Application Data
(60) Provisional application No. 62/703,588, filed on Jul. 26, 2018.

(51) Int. Cl. A01B 63/32; A01B 63/00; A01B 63/30; A01B 76/00; A01C 5/06

(52) U.S. Cl. CPC A01B 63/32; A01B 63/008; A01C 5/068; A01B 76/00; A01B 63/30

(57) ABSTRACT

The disclosed devices, systems and methods relate to an adaptive closing system for seed trench closing. The adaptive closing system including at least one row unit and a closing unit. The closing unit including at least one closing disc and an actuator. The adaptive closing system constructed and arranged to receive closing force inputs and generate closing force outputs to dynamically adjust the amount of downforce applied to the closing discs.

### CROSS REFERENCE TO RELATED APPLICATIONS

This application claims priority to U.S. Provisional Application 67/703,588, filed Jul. 26, 2018, and entitled “Apparatus, Systems and Methods for On-the-Go Closing Wheel Downforce Adjustment,” which is hereby incorporated herein by reference in its entirety.

### TECHNICAL FIELD

The disclosed technology relates generally to devices, systems and methods for use in agricultural planting, and in particular, to the devices, methods, and systems for closing seed trenches after seed placement and the application of downforce to the closing unit. This has implications for high speed, high yield planting of corn, beans and other agricultural crops.

### BACKGROUND

The disclosure relates to devices, systems and methods for use in agricultural planting applications. Failure to close the seed trench properly can lead to poor germination and poor development of nodal roots. Seed trenches that are left partially open allow air to contact nodal roots as they emerge (about 1″ above the seed). This open air contact with nodal roots will cause them the dry and die off causing rootless corn syndrome, also known as floppy corn syndrome. Further, partially open seed trenches can channel water runoff causing erosion of soil in the seed zone.

There is a need in the art for improved, efficient systems for the application of downforce to closing discs.

### BRIEF SUMMARY

Discussed herein are various devices, systems and methods relating to the closing of seed trenches during high speed planting.

Various implementations of the described adaptive closing system relate to a system having an actuator closing wheels that are operationally coupled to a supplemental downforce system. The adaptive closing system uses system data such as the amount of supplemental downforce applied/required as an indicia of ground hardness, and therefore the amount of force necessary to close the trench or furrow, as described herein.

In various Examples discussed herein, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Example 1 relates to an adaptive closing force system for attachment to a row unit including a closing unit, the adaptive closing force system including at least one closing actuator in operational communication with the row unit, and a processor, where the adaptive closing system is constructed and arranged to receive one or more closing force inputs to generate closing force output to increase, decrease or maintain closing actuator force. Other embodiments of Example 1 include corresponding computer systems, apparatus, and computer programs recorded on one or more computer storage devices, each configured to perform the actions of the methods.

Implementations according to Example 1 may include one or more of the following features. The adaptive closing force system where the at least one closing actuator further includes at least one of an airbag, a hydraulic actuator, a linear actuator or an electromagnetic actuator. The adaptive closing force system where the force applied by the at least one closing actuator on the at least one closing disc is a direct force or a force used to bias spring pressure. The adaptive closing force system where the at least one closing force input includes supplemental downforce applied by a supplemental downforce system on the row unit. The adaptive closing force system where the one or more closing force inputs includes at least one of historical data, field data, ground conditions, soil survey data, row unit acceleration and user inputs. The adaptive closing force system where the adaptive closing force system is constructed and arranged to generate at least one closing wheel score. Implementations of the described Example and techniques may include hardware, a method or process, or computer software on a computer-accessible medium.

Example 2 relates to an adaptive closing force system including at least one row unit including a supplemental downforce system, at least one closing unit including at least one closing disc and at least one closing actuator in operational communication with the at least one row unit and supplemental downforce system, and an control system including at least a processor, where the processor calculates a closing force output from the one or more closing force inputs, the closing force output is determinative of a closing force applied by the at least one closing actuator to the at least one closing disc, and the closing force output is updated based on changes in the one or more closing force inputs received by the closing actuator over time. Other embodiments of this Example include corresponding computer systems, apparatus, and computer programs recorded on one or more computer storage devices, each configured to perform the actions of the methods.

Implementations according to Example 2 may include one or more of the following features. The adaptive closing force system where the at least one closing actuator is selected from the group including of an airbag, a hydraulic actuator and a linear actuator. The adaptive closing force system where the closing force input includes at least one of supplemental downforce, roughness offset, row unit weight, seed weight, chemical weight, fluid weight, closing wheel downforce and row cleaner downforce. The adaptive closing force system where the processor is constructed and arranged to generate at least one closing wheel score. The adaptive closing force system where the processor is further constructed and arranged to compare the at least one closing wheel score to a baseline. The adaptive closing force system where the processor is further is constructed and arranged to receive user input data, and calculate and update the closing force output using the user input data. The adaptive closing force system where the operations system further includes a non-transitory computer-readable medium in operational communication with the processor. Implementations of the described techniques may include hardware, a method or process, or computer software on a computer-accessible medium.

Example 3 relates to an adaptive closing force system including at least one row unit including a supplemental downforce system, at least one closing system including at least one closing disc and at least one closing actuator in operational communication with the at least one row unit and the supplemental downforce system, and an control system including at least a processor, where changes to a closing force input generate changes in a closing force output applied by the at least one closing actuator to the at least one closing disc. Other embodiments of Example 3 include corresponding computer systems, apparatus, and computer programs recorded on one or more computer storage devices, each configured to perform the actions of the methods.

Implementations according to Example 3 may include one or more of the following features. The adaptive closing force system where the at least one closing actuator is selected from the group including of an airbag, a hydraulic actuator, an electromagnetic actuator and a linear actuator. The adaptive closing force system where the closing force input includes supplemental downforce. The adaptive closing force system where the closing force input includes at least one of roughness offset, row unit weight, seed weight, chemical weight, fluid weight, closing wheel downforce and row cleaner downforce. The adaptive closing force system where the actuator is constructed and arranged to increase, decrease or maintain closing actuator force in response to the closing force output. The adaptive closing force system where the closing force input is a time-series of values. The adaptive closing force system where the control system further includes a non-transitory computer-readable medium in operational communication with the processor. Implementations of the described techniques may include hardware, a method or process, or computer software on a computer-accessible medium.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a perspective view of a planter, according to one implementation.

FIG. 2A is a perspective view of a row unit and closing unit, according to one implementation.

FIG. 2B is a rear view of a row unit and closing unit, according to one implementation.

FIG. 2C is a side view of a row unit and closing unit, according to one implementation.

FIG. 3A is a schematic depiction of the adaptive closing system, according to one implementation.

FIG. 3B is a schematic depiction of the adaptive closing system, according to one implementation.

FIG. 4A is a process diagram for the operation of the adaptive closing system, according to one implementation.

FIG. 4B is a process diagram showing processing of closing force inputs, according to one implementation.

FIG. 5A depicts applied downforce on a row by row basis, according to one implementation.

FIG. 5B depicts a contour map of applied downforce, according to one implementation.

FIG. 6 depicts a contour map of various soil types, according to one implementation.

FIG. 7 depicts an exemplary user interface and the correlation between supplemental downforce and closing wheel downforce, according to one implementation.

### DETAILED DESCRIPTION

The various embodiments disclosed or contemplated herein relate to devices, methods, and systems for the closing of seed trenches behind individual row units in agricultural planting applications. That is, the disclosed adaptive closing system, methods and devices relate to the application of downforce to closing discs on a row unit. In various implementations the adaptive closing system is used in conjunction with and/or is integrated with a supplemental downforce system on a row unit.

The adaptive closing system and related methods and devices can be incorporated into and/or used with various other known devices, systems, and methods. For example, various implementations of the adaptive closing system may be incorporated into and/or used in conjunction with the supplemental downforce system shown and described in U.S. patent application Ser. No. 16/121,065, filed on Sep. 4, 2018, and entitled “Planter Down Pressure and Uplift Devices, Systems and Associated Methods”, which is hereby incorporated herein by reference in its entirety.

Various factors affect the amount of force necessary to properly close a seed trench after placement of a seed. For example, as ground hardness increases the force required to close the seed trench also increases. Proper closure of the seed trench is important in agricultural planting operations because, when trenches are not fully closed or are filled with loose soil, planted crops such as corn can fail to develop, resulting in, for example “floppy corn syndrome” or poor emergence. These issues caused by improper closure of the seed trench ultimately result is lost or low yields.

The application of downforce to closing discs on a row unit can ensure consistent trench closing thereby improving outcomes and ultimately increasing yield. Various implementations of the disclosed adaptive closing system relate to the application of downforce to the closing discs—including the application of downforce corresponding to ground conditions and row unit properties—sometimes understood as ground hardness—to ensure proper seed trench closure and prevent yield loss.

In various implementations featuring a supplemental downforce system, the disclosed adaptive closing system uses system data such as the amount of supplemental downforce applied/required as an indicia of ground hardness, and therefore the amount of force necessary to close the trench or furrow. That is, the disclosed system according to these implementations is able to utilize factors such as the amount of supplemental downforce being applied to the row unit to estimate ground hardness and therefore calibrate the quantity of additional closing force required to be applied to the closing unit in real time. It is understood that the disclosed implementations are able to approximate the amount of closing wheel downforce required to close trenches underlying individual row units without the need for additional, costly sensors, through use of one or more closing force inputs to establish and apply a closing force, as described herein.

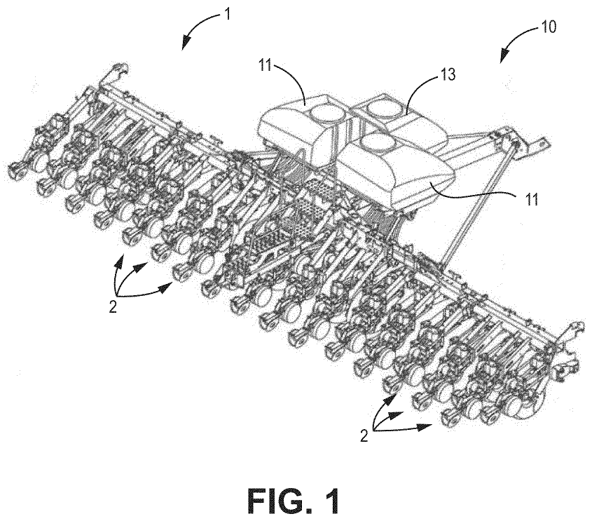

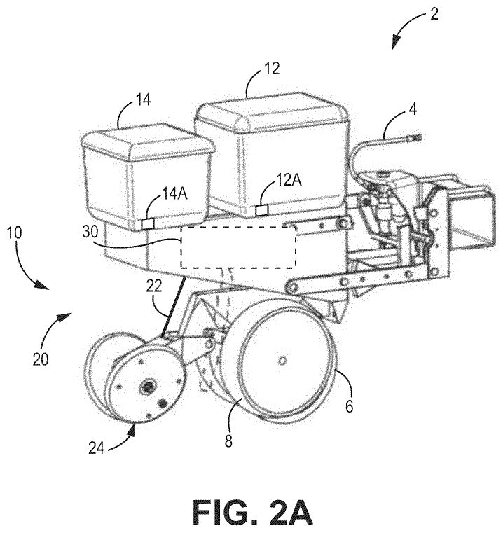

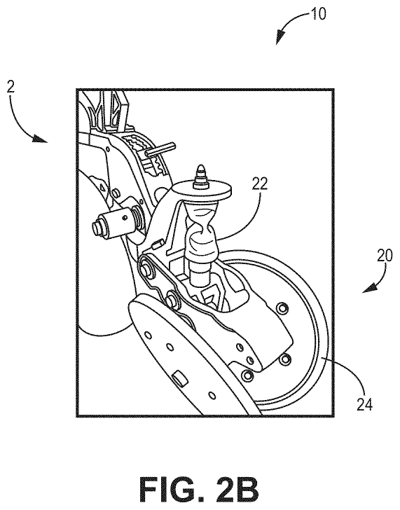

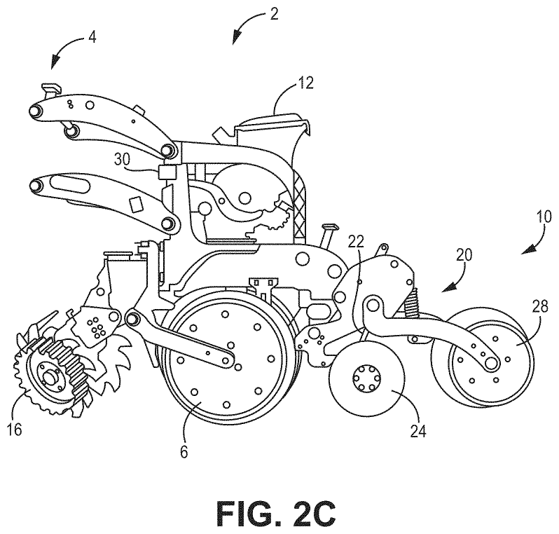

Turning to the figures in greater detail, FIG. 1 shows an exemplary planter 1 for use with the disclosed adaptive closing system 10. In various implementations, the planter 1 has a plurality of row units 2. In some implementations, seed reservoirs 11 and/or chemical reservoirs 13 may be disposed on the planter 1 and operatively connected to each individual row unit 2 to route seed and/or chemicals to those row units for application to the individual rows. However, in other implementations, each individual row unit 2 may include a row unit seed hopper 12 and/or row unit chemical hopper 14 (as shown in FIG. 2A). Various alternative configurations and planters 1 would be known and recognized by those of skill in the art.

FIGS. 2A-2C depict various implementations of row units 2. The row unit 2 includes the adaptive closing system 10. In some implementations, the adaptive closing system 10 includes a closing unit 20 affixed to the row unit 2 behind the opening discs 6 and gauge wheels 8. The closing unit 20 including a closing actuator 22 and at least one closing disc 24. It is understood that the closing actuator(s) 22, according to various implementations, may be pneumatic—that is, powered by air bags—though hydraulic, electromagnetic, and other known actuator types can also be used.

As discussed above, each row unit 2 may include various optional devices and systems. The row unit 2 according to certain implementations may include one or more of a supplemental downforce system 4, opening discs 6, gauge wheels 8, a seed hopper 12, a chemical hopper 14, and/or a row cleaner 16. In some implementations, the seed hopper 12 and chemical hopper 14 include a seed hopper sensor 12A and a chemical hopper sensor 14A, respectively. The seed hopper sensor 12A and the chemical hopper sensor 14A, according to these implementations, are constructed and arranged to detect the level, volume, and/or weight of seed or chemical in their respective hopper 12, 14. In implementations in which the sensors 12A and 14A detect the level to of contents within a hopper 12, 14, the detected level may be used by the adaptive closing system 10 to infer the weight of the contents of the hopper 12, 14. It would be understood by those of skill in the art that a row unit 2 may include any, all, or none of the above listed features, as well as additional components understood and/or known in the art. Additionally, the features and components may be present in myriad configurations, as would be understood.

As also discussed above, in various implementations, the row unit 2 has a supplemental downforce system 4 that operates to apply supplemental downforce to the row unit 2, such as those described previously and incorporated herein. This supplemental downforce may ensure that the seed trench is opened at the proper depth during planting—including high speed planting—through the application of supplemental downforce to the row unit 2.

In these and other implementations, the adaptive closing system 10 may be in operational communication with, or even incorporated into the supplemental downforce system 4 and function or otherwise operate in a coordinated fashion therewith. In various implementations, the adaptive closing system 10 is in operational communication with the supplemental downforce system 4 such that the adaptive closing system 10 can adjust and modify the amount of downforce applied to the closing discs 24 in relation—at least in part—to the amount of supplemental downforce that is applied to the row unit 2 by the supplemental downforce system 4. In various implementations the supplemental downforce system 4 can be used to provide information to the adaptive closing system 10 about the ground conditions, and therefore indicate the amount of closing wheel force that will be required. It is understood that in implementations featuring the supplemental downforce system 4, the closing system 10 can account for the downforce applied by the supplemental downforce system 4, as described herein.

Continuing with FIGS. 2A-2C, certain implementations of the closing units 20 include one or more closing discs 24 mounted behind the opening discs 6. The closing discs 24 are constructed and arranged to close the seed trench after seed has been planted therein. In some implementations, the one or more closing discs 24 may be mounted in pairs. In various alternative implementations, the closing unit 20 may be a two-stage closing unit having paired closing discs 24 and a press wheel 28, as shown in FIG. 2C.

In these implementations, a closing actuator 22 is operatively engaged with the closing discs 24 to apply downforce to the closing discs 24 and/or press wheel 28. As mentioned above, the closing actuator 22 may be a pneumatic actuator (as shown in FIG. 2B), a hydraulic actuator, a linear actuator coupled to a spring, a magnetic actuator, an electromagnetic linear variable force actuator, or any other known actuator or device capable of applying downforce to the closing discs 24, as would be appreciated.

Accordingly, the adaptive closing system 10 is constructed and arranged to adjust the downforce applied to the closing discs 24 via the closing actuator 22. In various implementations, the amount of downforce is adjusted in relation to recorded ground hardness to ensure proper trench closing in real time. In these and other implementations, the amount of downforce applied to the closing units 20 is adjusted by the adaptive closing system 10 based on closing force inputs and/or various sensor and other inputs.

For example, the closing force inputs may be, but are not limited to, ground roughness, soil type, the amount of supplemental downforce, row unit weight, seed weight, chemical weight, amount of closing wheel downforce, the amount of row cleaner downforce, historical data and/or various other factors and data types, as would be recognized by those of skill in the art.

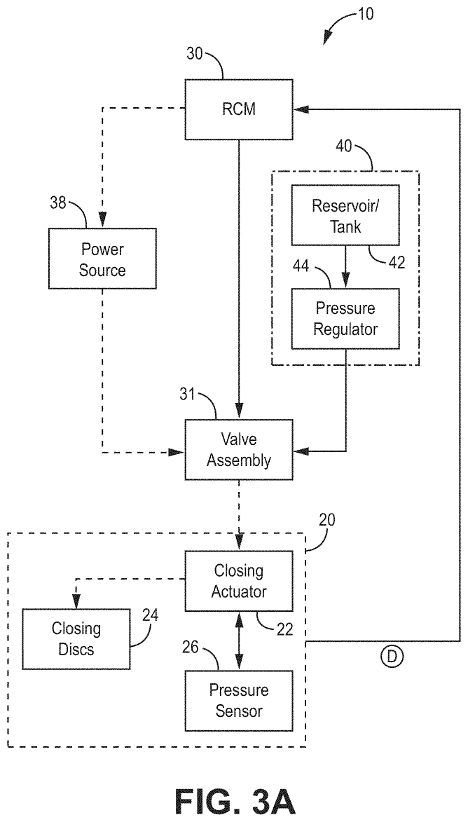

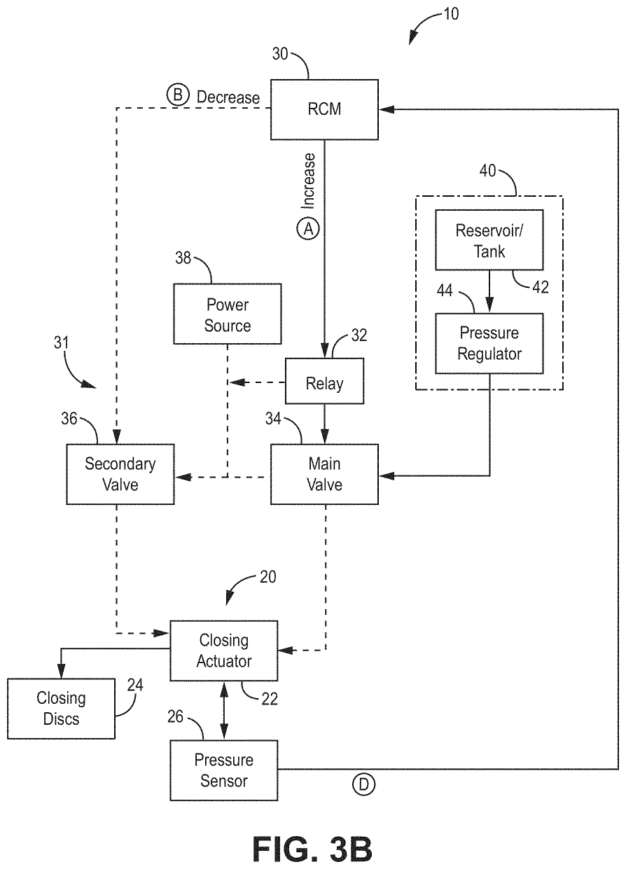

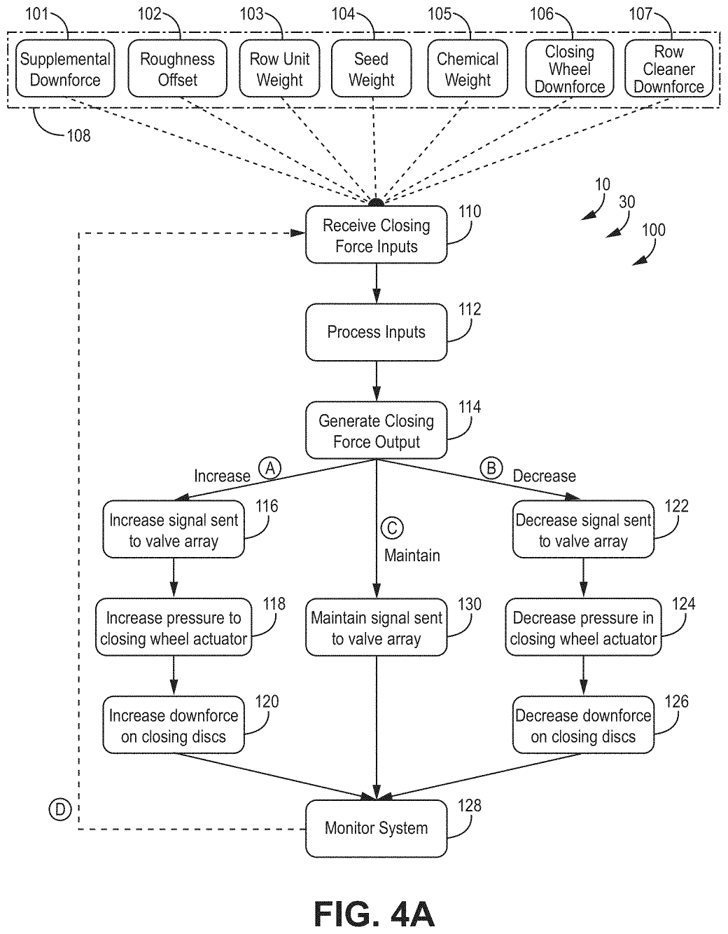

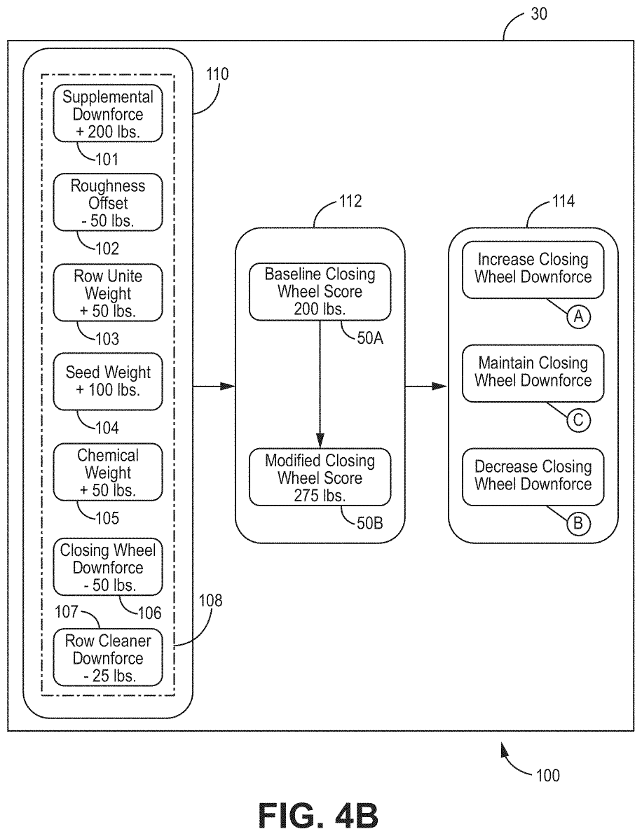

Turning to FIGS. 3A-B and 4A-B, FIGS. 3A-B are schematic representations of various components of the adaptive closing system 10 and FIGS. 4A-B are flow charts depicting exemplary logic that may be implemented by the control system 100 and row unit control module (“RCM”) 30. The control system 100 and RCM 30 are in operational communication with the closing actuator(s) 22 to adjust the amount of downforce being applied to the closing discs 24 on the various row units 2.

The control system 100 works with and as a part of the adaptive closing system 10. In some implementations, the adaptive closing system 10 has a control system 100 having a RCM 30, processor, or other processing device. The control system 100 is constructed and arranged to perform various steps to determine the proper amount of downforce to apply to the closing discs 24 for proper seed trench closure.

In various implementations, the control system 100 is incorporated into or otherwise in operational communication with the supplemental downforce system 4, which can be desirable in some implementations. The RCM 30 may be constructed and arranged to execute various software and/or logic to perform various operations and/or steps.

Turning back to FIGS. 3A and 3B, the adaptive closing system 10 according to these implementations includes a pressure system 40 which is in communication with a valve array 31 and the closing actuator 22. In various implementations, the valve array 31 has one or more valves, switches, relays and other components for communication of signals from the RCM 30 to the valve relay 31 and the flow of pressure from the pressure system 40 to the closing actuator 22.

In use according to these implementations, the pressure system 40 applies downforce to the closing actuator 22 via the valve array 31. The pressure system 40 can include a reservoir or tank 42 and a pressure regulator 44 configured to supply, monitor and control pressure to the closing actuator 22. The pressure regulator 44 is constructed and arranged to control the flow out of and within the tank 42. In various implementations, the pressure system 40 is a pneumatic system, as shown in FIG. 2B. In various alternative implementations, the pressure system 40 is a hydraulic system, such as a hydraulic system associated with the supplemental downforce system 4, or in some implementations is a separate system.

In various implementations, the adaptive closing system 10 controls the amount of downforce applied to the closing discs 24 via an open feedback loop, shown in FIGS. 3A-B and 4A-B. In these and other implementations, the adaptive closing system 10 includes a pressure sensor 26 operatively engaged with the closing actuator 22 to detect the amount of downforce or pressure within the closing actuator 22 as an indicator of the amount of downforce being applied to the ground by the closing discs 24. The sensed pressure is transmitted to the RCM 30 for processing/updating of the closing force output.

In various implementations, the RCM is constructed and arranged to receive (box 110) various closing force inputs 108/closing wheel score 50—as will be discussed further below in reference to FIGS. 4A and 4B—and process (box 112) the various closing force inputs 108/scores 50 to establish a closing force output (box 114), that is the amount of closing wheel downforce to be applied to the closing wheels. In various implementations, establishing a closing force output (box 114) includes processing the one or more inputs 108 to establish a closing wheel score 50. It is understood that the closing wheel scores 50 can be dynamic, that is the closing wheel scores 50 can change over time in response to a time-series of data—the various closing force inputs 108 processed in the RCM.

That is, in exemplary implementations, the various closing force inputs 108 are processed in real time by the processor/RCM to establish a time series of closing wheel scores 50 that, in turn are transformed into closing force outputs (box 114) so as to command the closing wheel actuator to increase, decrease or maintain closing wheel downforce. In certain implementations, the closing force inputs 108 are benchmarked to a baseline closing wheel score 50A that is modified to generate a final closing wheel score 50B. It is understood for purposes of this example that the baseline and final closing wheel scores are illustrated with 50A and 50B, but that in practice the closing wheel score 50 is being continually modified on the basis of the various closing force inputs 108 and for simplicity elsewhere will be understood to be a dynamic score 50 that represents the time-series of modifications occurring throughout the process. It is understood that the closing wheel score 50B may be processed and adjusted via various mathematical operations to generate closing force outputs (box 114) or commands, thereby causing dynamic adjustments to the applied closing wheel downforce.

After the sensed pressure and various other closing force inputs 108 are processed (box 112) the RCM 30 generates a closing wheel score 50 and emits a closing force output (box 114) to either increase (arrow A), decrease (arrow B), or maintain (arrow C) the amount of downforce being applied to the closing discs 24. These adjustments to the amount of closing wheel downforce are made dynamically and in real-time or near real-time. The output signal from the RCM 30 is sent to the valve array 31. The output signal from the RCM 30 may be a binary signal or a linear signal, as would be appreciated.

In various implementations, the valve array 31 is a signal valve capable of increasing, decreasing, and maintaining pressure within the closing wheel actuator 22. In various alternative implementations, the valve array 31 includes a relay 32, a main valve 34, and a secondary valve 36. The valve array 31 may include various devices in a plurality of configurations, as would be recognized by those of skill in the art.

When the amount of downforce is insufficient the RCM 30 generates an increase signal or command (box 114; arrow A) which signals the control system 100 to increase the amount of downforce being applied to the closing discs 24. In one such implementation, the increase signal is sent to the valve array 31 (box 116) which through a series of one or more valves or actions cause the pressure within the closing wheel actuator 22 to increase (box 118). The increased pressure in the closing wheel actuator 22 is translated into increased downforce applied to the closing wheels 24 (box 120).

In one specific implementation, shown in FIG. 3B, to increase the amount of downforce, the increase signal (arrow A) activates a relay 32. The relay 32 signals the power source 38 to send the voltage to the main valve 34 (box 116). When the voltage is sent to the main valve 34, the main valve 34 allows additional pressure from the pressure system 40 to flow to the closing actuator 22 (box 118), thereby increasing downforce on the closing discs 24 (box 120).

In these and other implementations, the increased downforce on the closing discs 24 is sensed by the pressure sensor 26 (box 128). The pressure sensor 26, continuously or periodically, transmits a pressure signal to the RCM 30 (arrow D) thereby maintaining the feedback loop.

When the adaptive closing system 10 determines that too much downforce is being applied to the closing discs 24 the RCM 30 generates a decrease signal (box 114; arrow B) which signals the control system 100 to decrease the amount of downforce being applied to the closing discs 24. The decrease signal is sent to the valve array 31 (box 122) which through a series of one or more valves or actions—discussed above—cause the pressure within the closing wheel actuator 22 to decrease (box 124). The decreased pressure in the closing wheel actuator 22 is translated into decreased downforce applied to the closing discs 24 (box 126).

In one specific implementation, shown in FIG. 3B, to decrease the amount of downforce, the decrease signal (arrow B) signals the power source 38 to send voltage to the secondary valve 36 (box 122). The secondary valve 36 then allows pressure to flow out of the closing actuator 22 (box 124). The decreased pressure in the closing actuator 22 thereby decreases the amount of downforce applied to the closing discs 24 (box 126).

As discussed above, in these implementations, the change in pressure on the closing discs 24 can be sensed by the pressure sensor 26 (box 128) and the pressure sensor 26 transmits the pressure signal to the RCM 30 (arrow D).

Further the adaptive closing system 10 and control system 100 may determine that the proper amount of downforce is being applied to the closing discs 24. When the proper amount of closing wheel downforce is being applied the RCM 30 generates a maintain signal (box 114)(arrow C). The maintain signal may be transmitted to the valve array 31 (box 130) indicating to maintain the current parameters. The adaptive closing system 10 and control system 100 then continue to monitor the system and pressure at the closing discs 24 (box 128). In various of these implementations, and as discussed above, pressure signals from the pressure sensor 26 are continuously or periodically communicated to the RCM 30 (arrow D) as part of the feedback loop.

As shown in FIGS. 4A and 4B the RCM 30 and/or control system 100 are constructed and arranged to receive (box 110) closing force inputs 108 (shown variously in boxes 101-107), which may include applied downforce of the supplemental downforce system 4 and various other measurements. In establishing the closing force output (box 114), the control system 100 may additionally calculate closing wheel scores 50 over time using the received closing force inputs 108. The control system 100 may additionally be constructed and arranged to determine one or several parameters including a dynamic closing wheel score 50. Finally, the control system 100 is constructed and arranged to activate and operate the at least one closing actuator 22 so as to control the downforce applied to one or more closing discs 24.

More specifically, as shown in FIGS. 4A and 4B, the RCM 30 can be constructed and arranged to execute the control system 100 to establish the correct amount of downforce and operate the valve array 31 and closing actuator 22 accordingly. The control system 100 receives the various closing force inputs 108 (at box 110) which may include, but are not limited to, supplemental downforce 101, ground roughness offset 102, row unit weight 103, seed weight 104, chemical weight 105, closing wheel downforce 106, row cleaner downforce 107 and various historical, soil and other data. Further implementations feature additional optional closing force inputs 108, and it is of course understood that not all of the listed closing force inputs 108 are necessary for the functioning of the system. The closing force inputs 108 may be received from various sensors on the row unit 2, planter 1, and/or supplemental downforce system 4, user entry, and/or various storage devices.

In exemplary implementations, the RCM 30 is constructed and arranged to calculate a time series of values in response to various closing force inputs 108 and establish the closing force output (box 114): the proper amount of downforce that should be applied to the closing discs 24 based on the received closing force inputs. As previously discussed, applying the proper amount of downforce via the closing actuator 22 helps to ensure proper seed trench closing and thereby improve performance of the adaptive closing system 10 and planter operations.

In some implementations, the closing force inputs 108 include historical data that may be stored in various storage devices in communication with the RCM 30 and control system 100. Historical data used as a closing force input 108 may include, but is not limited to historical field data, ground hardness, and other conditions, such as a soil survey data, row unit acceleration, other ground conditions information indicating cloddy ground conditions, and various other types of data that would be understood and appreciated by those of skill in the art.

Further implementations are adapted to allow for user input and/or manual adjustments closing wheel downforce. For example, a user may manually adjust the amount of force to be applied as a percentage or quantity of total force or a constant increase or decrease in absolute force applied.

In these and other implementations, the control system 100, after receiving the various closing force inputs 108 (at box 110), processes the closing force inputs (box 112). Processing the closing force inputs (box 112) and generating a closing wheel output (box 114) may include calculating a closing wheel score 50, as shown in FIG. 4B. After the inputs are processed, the control system 100 generates closing force output (box 114). The closing force output (box 114) then can indicate either to increase (arrow A), decrease (arrow B), or maintain (arrow C) the amount of closing wheel downforce, as discussed above.

The closing wheel scores 50 may be calculated by the RCM 30 and control system 100 (box 112) while processing the closing force inputs 108. The control system 100 may calculate the closing wheel score 50 on the basis of the various closing force inputs (see boxes 101-107 above), in addition to various other variables and inputs as would be recognized by those of skill in the art. In some implementations, a microcontroller receives and stores orientation data from the various sensors and is constructed and arranged to determine the closing wheel score 50, as would be understood by one of skill in the art.

Several factors can be used to establish the closing wheel score 50. Various closing force factors 108 may include supplemental downforce 101, roughness offset 102, row unit weight 103, seed weight 104, chemical weight 105, closing wheel downforce 106, row cleaner downforce 107, among others that would be recognized by those of skill in the art. It is understood that in certain implementations, the closing wheel score 50 can change from row-to-row, by the yard, second, or other measure, so as to adapt in real time to varying ground hardness and other data points.

Supplemental Downforce 101.

In various implementations, the applied supplemental downforce 101 can optionally be used as a closing force input 108 to establish a closing wheel score 50 or baseline closing wheel score 50. The baseline value can be adjusted based on various other inputs and values in subsequent steps to establish a modified closing wheel score 50. In these implementations, the row unit 2 has a supplemental downforce system 4 and the amount of supplemental downforce 101 is used as the baseline in establishing the closing wheel score 50.

The amount of supplemental downforce being applied to the row unit 2 can be utilized by the adaptive closing system 10 to determine the approximate amount of downforce necessary for proper seed trench closing. For example, the supplemental downforce system 4 will apply an increased amount of supplemental downforce to the row unit 2 when the ground becomes harder or the planter speed is increased. These changes in ground hardness and/or planting speed may also, indicate a need for an increased amount of downforce to be applied to the closing discs 24.

In various implementations, the amount of supplemental downforce 101 can be obtained via electronic communication with the supplemental downforce system 4. Of course other sources are possible. In various implementations, the closing wheel score 50 is initially established as the amount of instantaneous supplemental downforce, thereby establishing the initial closing wheel score 50 prior to any subsequent offsets and/or adjustments.

In one specific example, shown in FIG. 4B, the amount of supplemental downforce is 200 lbs, as such the initial/baseline closing wheel score 50 is 200 lbs. The closing wheel score 50 can then be compared to the desired amount of closing wheel downforce to determine the closing force output (box 114), i.e., if the amount of closing wheel downforce should be increased, decreased, or maintained at the current level. This specific example is given for illustrative purposes only and is not to be construed as limiting.

Roughness Offset 102.

The closing wheel score 50 may be adjusted by an optional roughness offset, in certain implementations. The roughness offset is a measurement of ground roughness which can be a dynamic closing force input 108, that is the roughness offset may vary over time.

In various implementations, it is advantageous to eliminate any offsets to target gauge wheel load imparted by ground roughness for closing wheel control when determining the closing wheel score 50. In certain implementations, it is possible to measure the variation in the load on the gauge wheels 8 over a short timeframe to determine how rough the soil is.

The amount of roughness offset may be determined by analyzing historical and other data. This historical data may include data related to the gauge wheel load. For example, in areas with low to no roughness related to soil clodding, the gauge wheel load over time would have a lower variance, while cloddy soil will cause the gauge wheel load over time to have a high variance.

Rough soil conditions may cause the row unit 2 to move in various directions including vertically. The planter 1 and the supplemental downforce system 4 may apply additional supplemental downforce to the row unit 2 to minimize the effect of this row unit 2 movement and ensure seeds are planted at the proper depth. The closing unit 20, including the closing discs 24, is typically smaller than the row unit 2, and is not affected by soil roughness to the same degree as the row unit 2. As such, the adaptive closing system 10 can use both the amount of supplemental downforce 101 and gauge wheel load values over time to determine a roughness offset 102.

Continuing with the specific example above, the closing wheel score 50 is reduced by the roughness offset 102 of 50 lbs. The roughness offset 102 may be subtracted from the baseline closing wheel score 50A (200 lbs.-50 lbs.=150 lbs.). Various other implementations and methods of determining ground roughness are possible and would be understood by those of skill in the art.

Row Unit Weight 103.

The ground hardness score 50 may additionally be adjusted to account for the row unit weight 103, a further optional closing force input 108. The row unit weight 103 is generally constant. The row unit weight 103 may be the weight of the row unit 2 alone or the row unit weight 103 may include the weight of the row unit 2 including any attachments, components, or other accessories, such as seed hoppers 12 and chemical hoppers 14. The row unit weight 103 can vary, depending on the type of planter, the planter attachments, and a variety of other factors that would be recognized by those of skill in the art.

The amount of row unit weight 103 is additional downforce applied to the ground and opening discs 6 that is not captured by the amount of supplemental downforce from the supplemental downforce system 4. As such, the adaptive closing system 10 may use the row unit weight 103 in addition to the amount of supplemental downforce to determine the total amount of downforce being applied to the ground and opening discs 6 by the row unit 2. This total amount of downforce is an indicia of ground and system conditions which may affect the amount of downforce that should be applied to the closing discs 24.

Continuing with the specific example above the row unit weight 103 is 50 lbs. The row unit weight 103 is added to the baseline closing wheel score 50A, or to the adjusted/modified closing wheel score 50B (150 lbs.+50 lbs.=200 lbs).

Seed Weight 104.

In some implementations, the closing wheel score 50 may additionally be adjusted to account for seed weight 104, a further optional closing force input 108. The seed weight may be relevant to the closing wheel score in implementations in which each row unit 2 has its own seed hopper 12 (such as that shown in FIG. 2A). Individual seed hoppers 12, on the row units 2, can add a significant amount of weight to the row unit 2—for example about 150 lbs. or more—when the seed hopper 12 is full.

As the planter 1 and row units 2 traverse a field and plant seeds the amount of seed in the seed hopper 12 decreases therefore the amount of weight added to the row unit 2 by the seed hopper 12 also decreases. As the weight on the row unit 2 added by the seed hopper 12 decreases the supplemental downforce applied by the supplemental downforce system 4 must increase to compensate for the lost weight.

When determining the ground hardness score 50 the amount of weight added by the seed in the seed hoppers 12 can be measured. In various implementations the amount of seed weight 104 is inputted separate from the row unit weight 103. In various alternative implementations, the seed weight 104 may be included in the determination of row unit weight 103 (discussed above) and need not be measured independently.

Various systems, methods, and devices may be used to determine the amount of seed in a seed hopper 12 and the corresponding seed weight 104. In some implementations, a seed hopper sensor 12A is installed in the seed hopper 12 to measure the volume of seed remaining (as shown in FIG. 2A). The volume of seed remaining is used to estimate the amount of seed weight on the row unit 2. Some non-limiting examples of seed hopper sensors 12A are optical, ultrasonic and/or resistive sensors. These various sensor types may be implemented alone or in combination.

In various alternative implementations, a user is able to input the amount of seed in the seed hopper 12. In various of these implementations, the planter 1 and adaptive closing system 10 count the number of seeds planted and thereby estimate the number of seeds remaining in the seed hopper 12 and the corresponding weight of the remaining seed.

In one example, a bag of corn seeds may contain about 80,000 seeds, and has a weight between about 32 and 70 lbs. The user can input the appropriate weight and seed number into the adaptive closing system 10. In various implementations, two bags of seed are placed into each seed hopper 12. As each seed is planted the seed weight 104 is reduced by the weight of one seed (in one such illustrative example, approximately 1/160,000 of the total seed weight inputted) by the adaptive closing system 10.

In various other implementations, the seed weight 104 can be estimated based on knowledge of the crop type being planted.

Returning to the example of FIG. 4B, the closing wheel score 50 may be adjusted based on the seed weight 104. The amount of seed weight 104 in the seed hopper 12 is additional weight on the row unit 2 and is added to the baseline closing wheel score 50 to determine a modified closing wheel score 50B (200 lbs.+100 lbs.=300 lbs.).

Chemical Weight 105.

In some implementations, the closing wheel score 50 may additionally be adjusted to account for the weight of chemicals or other fluid(s) in a chemical hopper 14. The chemical or fluid weight 105 is a further optional closing force input 108 where it may be relevant to the closing wheel score 50, such as in implementations in which each row unit 2 has its own chemical hopper 14 (such as that shown in FIG. 2A). Similar to the seed hopper 12 (discussed above), various row units 2 include individual chemical hoppers 14 to hold various chemicals and fluids that may be applied to a field during planting. The various chemicals or fluids may include, but are not limited to, granular insecticide products and/or other chemical additives as would be understood in the art.

The various methods and systems for determining the amount of chemical weight 105 are similar to those discussed above in relation to seed weight 104. For example, a chemical hopper sensor 14A (shown in FIG. 2A) may be disposed on or in the chemical hopper 14 to determine the level of chemical or fluid within the chemical hopper 14. In another example, the adaptive closing system 10 is constructed and arranged such that a user can input the amount of fluid or chemical in the chemical hopper 14 and then the control system 100 may subsequently adjust and recalculate the chemical weight 105 over time as the chemical is applied during planting.

Alternatively, the amount of chemical weight 105 may be included in the input of overall row unit weight 103 and need not be separately measured.

Continuing with the exemplary calculation of FIG. 4B, the chemical weight 105 is added to the baseline closing wheel score 50A to determine a modified closing wheel score 50B (300 lbs.+50 lbs.=350 lbs.).

Closing Wheel Downforce 106.

In some implementations, the baseline closing wheel score 50 may additionally be adjusted to account for the closing wheel downforce 106, a further optional closing force input 108. The closing discs 24 are typically mounted on the row unit 2, such that downforce applied to the closing discs 24 reduces the downforce on the row unit 2. Said another way, supplemental downforce on the closing discs 24 may cause upforce on the row unit 2. This upforce on the row unit 2 may be a factor the control system 100 uses when determining the correct amount of downforce to apply to the closing discs 24.

In the example of FIG. 4B, 50 lbs. of downforce is being applied to the closing discs 24, which in turn may transmits upforce to the row unit 2. In various implementations, the upforce from the closing discs 24 is counteracted by the supplemental downforce system 4, which applies supplemental downforce to the row unit 2 to ensure proper planting depth.

In the specific implementation of FIG. 4B, the amount of closing wheel downforce 106 is subtracted from the baseline closing wheel score 50A to determine a modified closing wheel score 50B (350 lbs.−50 lbs.=300 lbs.).

Row Cleaner Downforce 107.

In various implementations, the adaptive closing system 10 may include the amount of row cleaner downforce as a further optional closing force input 108 when determining the closing wheel score 50. In various implementations, the amount of row cleaner downforce 107 is generally constant. Similar to the closing wheel downforce 106—discussed above—the row cleaner downforce 107 affects the overall downforce on the row unit 2.

In some implementations, the row unit 2 has an adjustable force row cleaner 16 (shown in FIG. 2C). The row cleaner 16 is often attached at the front of the row unit 2 such as to clear debris away from the seed trench prior to opening the seed trench. The downforce applied by the row cleaner 16 may cause a corresponding upforce on the row unit 2. This upforce may be counteracted by the supplemental downforce system 4.

In the exemplary calculation of FIG. 4B, a row cleaner downforce of is subtracted from the baseline closing wheel score 50A to determine the modified closing wheel score 50B (300 lbs.−25 lbs.=275 lbs.).

Many other sources of ground, system, and other data and closing force inputs 108 can be used to determine the closing wheel score 50. In some of these implementations the closing wheel score is determined in real-time or in near real-time. In these and other implementations, the closing wheel score 50 may be used to establish the amount of downforce that should be applied the closing discs 24 via the closing actuator 22 for proper trench closing and/or if the amount of downforce that is being applied to the closing discs 24 should be maintained, increased, decreased.

The adaptive closing system 10, RCM 30, and control system 100 may use various hardware, software, and other computing devices. One or more computing devices may be adapted to provide desired functionality by accessing software instructions rendered in a computer-readable form. When software is used, any suitable programming, scripting, or other type of language or combinations of languages may be used to implement the teachings contained herein. However, software need not be used exclusively, or at all. For example, some embodiments of the methods and systems set forth herein may also be implemented by hard-wired logic or other circuitry, including but not limited to application-specific circuits. Combinations of computer-executed software and hard-wired logic or other circuitry may be suitable as well.

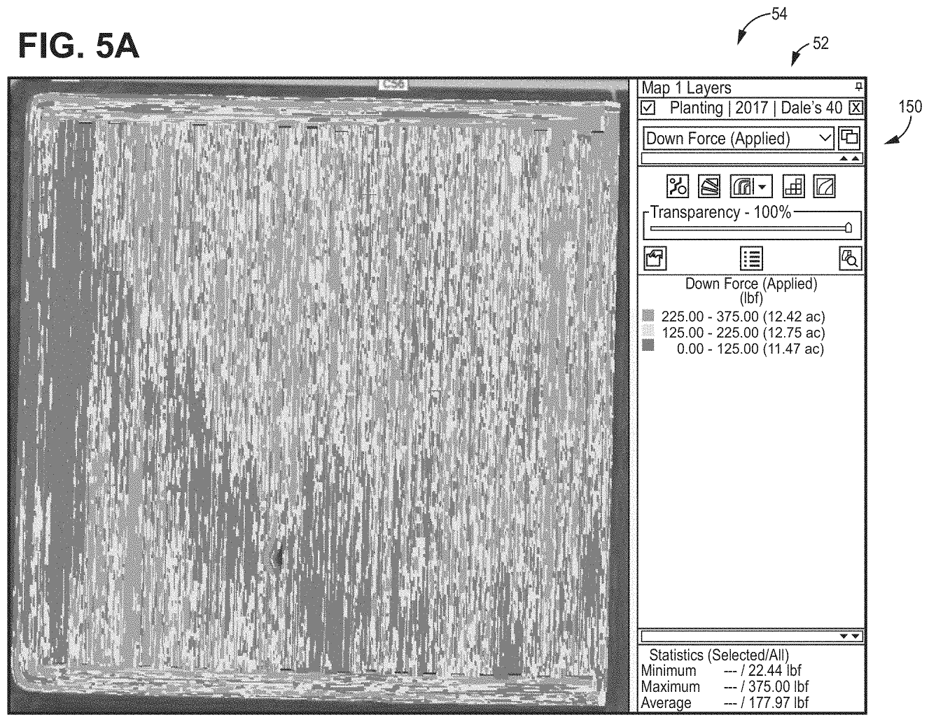

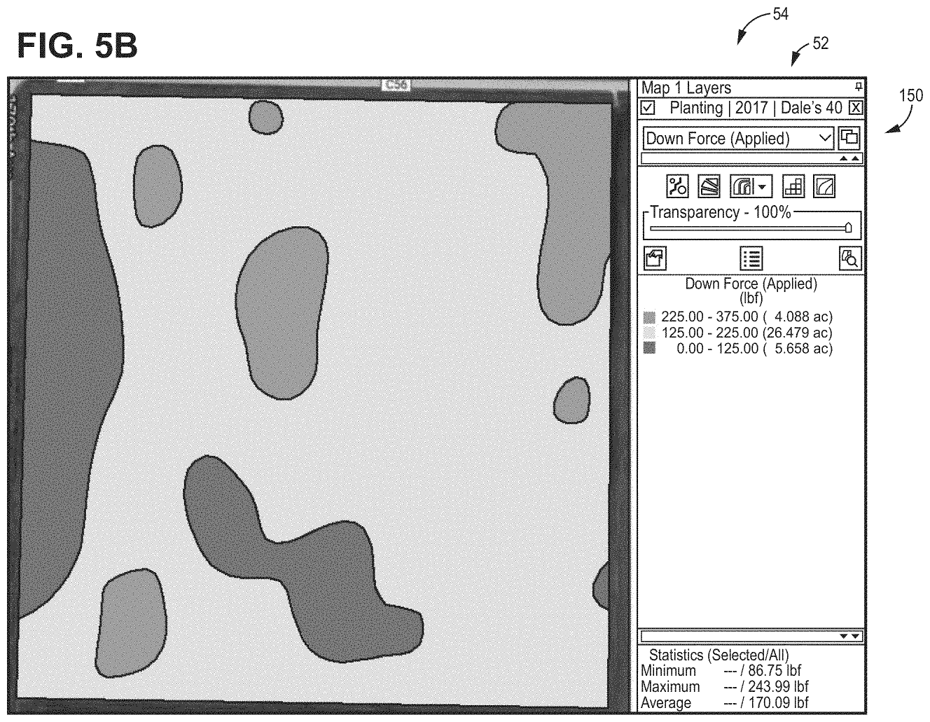

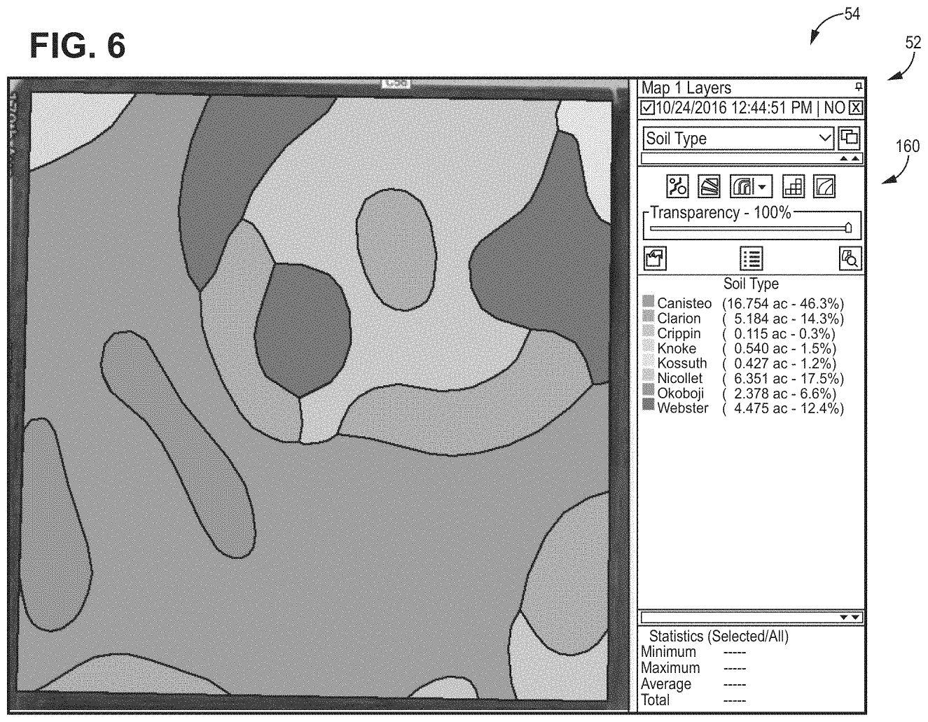

FIG. 5A shows the downforce applied on a row-by-row basis and FIG. 5B shows the downforce applied in a contour map. Historical closing wheel downforce 150, may include the amount of closing wheel downforce applied in previous season or planting, and may be an additional closing force input 108 that can be utilized by the adaptive closing system 10 to establish the appropriate amount of closing wheel downforce to be applied in a current or future planting cycle. The amount of downforce required to properly close a seed trench may also be affected by soil type. A soil type map, shown in FIG. 6, includes soil type data 160 indicating the soil type in various portions of a field or planting area. This soil type data 160 can be used as an additional closing force input 108 by the adaptive closing system 10 to determine the appropriate amount of downforce needed in current and future plantings.

It is additionally possible to use a map or data related to soil hardness to generate a closing wheel downforce prescription map. In additional implementations, the drainage class and/or topography of the land may be further closing force inputs 108, used in establishing closing wheel downforce. It would be understood that these various closing force inputs 108 may be used alone or in any combination to determine the appropriate amount of downforce that should be applied to the closing wheels 24.

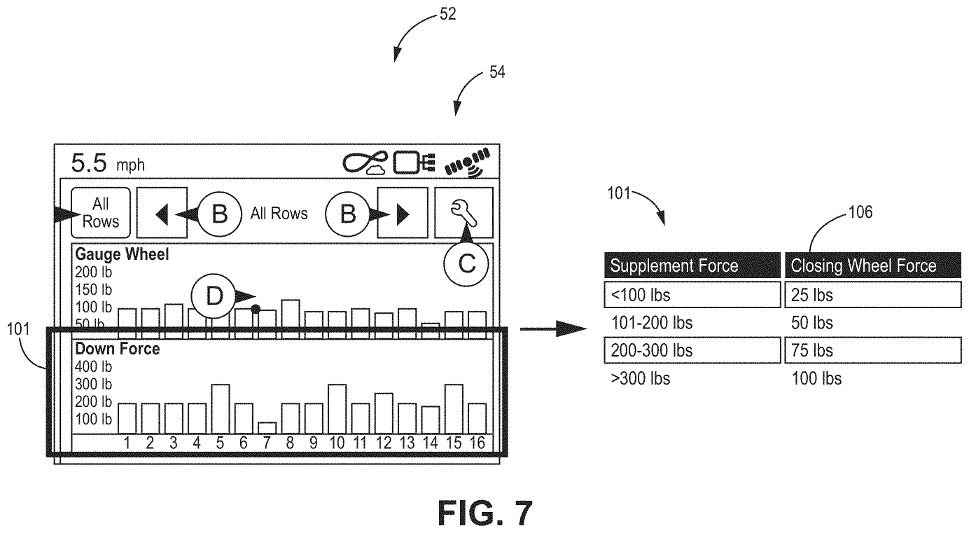

In various implementations, such as that of FIG. 7, a user can manually adjust the application of closing wheel downforce via a graphical user interface 54, that is as discussed above, the user is able to add or subtract relative or absolute amounts of closing wheel downforce via the graphical user interface, as would be readily understood. The graphical user interface 54 may be part of a monitor 52 or other display device as would be recognized and appreciated by those of skill in the art. As shown in FIG. 7, and as discussed above, the amount of supplemental downforce applied by the supplemental downforce system 4 along with the closing wheel score 50 can serve as an indicia of ground hardness and soil conditions, which then can serve as the basis for determining if the proper amount of closing wheel downforce is being applied.

In some implementations, the supplemental downforce data is recorded and/or stored by the adaptive closing system 10 in real-time or near-real time for adaptive adjustment as the row unit 2 traverses a field.

Embodiments of the methods disclosed herein may be executed by one or more suitable computing devices. Such system(s) may comprise one or more computing devices adapted to perform one or more embodiments of the methods disclosed herein. As noted above, such devices may access one or more computer-readable media that embody computer-readable instructions which, when executed by at least one computer, cause the at least one computer to implement one or more embodiments of the methods of the present subject matter. Additionally or alternatively, the computing device(s) may comprise circuitry that renders the device(s) operative to implement one or more of the methods of the present subject matter.

Any suitable computer-readable medium or media may be used to implement or practice the presently-disclosed subject matter, including but not limited to, diskettes, drives, and other magnetic-based storage media, optical storage media, including disks (e.g., CD-ROMS, DVD-ROMS, variants thereof, etc.), flash, RAM, ROM, and other memory devices, and the like.

Different arrangements of the components depicted in the drawings or described above, as well as components and steps not shown or described are possible. Similarly, some features and sub-combinations are useful and may be employed without reference to other features and sub-combinations.

Although the disclosure has been described with reference to preferred embodiments, persons skilled in the art will recognize that changes may be made in form and detail without departing from the spirit and scope of the disclosed apparatus, systems and methods.

What is claimed is:

1. An adaptive closing force system for attachment to a row unit comprising a closing unit, the adaptive closing force system comprising:
a) at least one closing actuator in operational communication with the row unit; and
b) a processor,
wherein the adaptive closing system is constructed and arranged to receive one or more closing force inputs to generate closing force output to increase, decrease or maintain closing actuator force.

2. The adaptive closing force system of claim 1, wherein the at least one closing actuator further comprises at least one of an airbag, a hydraulic actuator, a linear actuator and an electromagnetic actuator.

3. The adaptive closing force system of claim 1, wherein the force applied by the at least one closing actuator on the at least one closing disc is a direct force or a force used to bias spring pressure.

4. The adaptive closing force system of claim 1, wherein the at least one closing force input comprises supplemental downforce applied by a supplemental downforce system on the row unit.

5. The adaptive closing force system of claim 4, wherein the one or more closing force inputs comprises at least one of roughness offset, row unit weight, seed weight, chemical weight, fluid weight, closing wheel downforce and row cleaner downforce, historical data, field data, ground conditions, soil survey data, row unit acceleration and user inputs.

6. The adaptive closing force system of claim 1, wherein the adaptive closing force system is constructed and arranged to generate at least one closing wheel score.

7. An adaptive closing force system comprising:
a) at least one row unit comprising a supplemental downforce system;
b) at least one closing unit comprising at least one closing disc and at least one closing actuator in operational communication with the at least one row unit and supplemental downforce system; and
c) an control system comprising at least a processor,
wherein:
i) the processor calculates a closing force output from the one or more closing force inputs,
ii) the closing force output is determinative of a closing force applied by the at least one closing actuator to the at least one closing disc, and
iii) the closing force output is updated based on changes in the one or more closing force inputs received by the closing actuator over time.

8. The adaptive closing force system of claim 7, wherein the at least one closing actuator is selected from the group consisting of an airbag, a hydraulic actuator and a linear actuator.

9. The adaptive closing force system of claim 7, wherein the closing force input comprises at least one of supplemental downforce, roughness offset, row unit weight, seed weight, chemical weight, fluid weight, closing wheel downforce and row cleaner downforce.

10. The adaptive closing force system of claim 7, wherein the processor is constructed and arranged to generate at least one closing wheel score.

11. The adaptive closing force system of claim 10, wherein the processor is further constructed and arranged to compare the at least one closing wheel score to a baseline.

12. The adaptive closing force system of claim 7, wherein the processor is further is constructed and arranged to:
a) receive user input data; and
b) calculate and update the closing force output using the user input data.

13. The adaptive closing force system of claim 7, wherein the operations system further comprises a non-transitory computer-readable medium in operational communication with the processor.

14. An adaptive closing force system comprising:
a) at least one row unit comprising a supplemental downforce system;
b) at least one closing system comprising at least one closing disc and at least one closing actuator in operational communication with the at least one row unit and the supplemental downforce system; and
c) an control system comprising at least a processor,
wherein changes to a closing force input generate changes in a closing force output applied by the at least one closing actuator to the at least one closing disc.

15. The adaptive closing force system of claim 14, wherein the at least one closing actuator is selected from the group consisting of an airbag, a hydraulic actuator, an electromagnetic actuator and a linear actuator.

16. The adaptive closing force system of claim 14, wherein the closing force input comprises supplemental downforce.

17. The adaptive closing force system of claim 14, wherein the closing force input comprises at least one of roughness offset, row unit weight, seed weight, chemical weight, fluid weight, closing wheel downforce and row cleaner downforce.

18. The adaptive closing force system of claim 14, wherein the actuator is constructed and arranged to increase, decrease or maintain closing actuator force in response to the closing force output.

19. The adaptive closing force system of claim 18, wherein the closing force input is processed as a closing score comprising a time-series of values.

20. The adaptive closing force system of claim 14, wherein the control system further comprises a graphical user interface.
